(19) United States
(12) Patent Application Publication
(10) Pub. No.: US 2006/0165302 A1
(43) Pub. Date: Jul. 27, 2006

(54) Method of multi-layer based scalable video encoding and decoding and apparatus for the same

(75) Inventors: Woo-Jin Han, Suwon-si (KR); Sang-Chang Cha, Hwaseong-si (KR); Bae-Keun Lee, Bucheon-si (KR); Ho-Jin Ha, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/336,826

(22) Filed: Jan. 23, 2006

Related U.S. Application Data
(60) Provisional application No. 60/645,008, filed on Jan. 21, 2005.

(30) Foreign Application Priority Data
Mar. 16, 2005 (KR) 10-2005-0021801

(51) Int. Cl. G06K 9/46

(52) U.S. Cl. 382/240

(57) ABSTRACT

A method of multi-layer based scalable video encoding and decoding and an apparatus for the same are disclosed. The encoding method includes the steps of estimating motion between a base layer frame that is placed at a temporal location closest to a current frame of an enhancement layer, and a frame that is backwardly adjacent to the base layer frame to acquire a motion vector, generating a residual image by subtracting the backwardly adjacent frame from the base layer frame, generating a virtual forward reference frame using the motion vector, the residual image and the base layer frame, and generating a predicted frame with respect to the current frame using the virtual forward reference frame, and encoding the difference between the current frame and the predicted frame.

### CROSS-REFERENCE TO RELATED APPLICATIONS

This application claims priority from Korean Patent Application No. 10-2005-0021801 filed on Mar. 16, 2005 in the Korean Intellectual Property Office, and U.S. Provisional Patent Application No. 60/645,008 filed on Jan. 21, 2005 in the United States Patent and Trademark Office, the disclosures of which are incorporated herein by reference in their entirety.

### BACKGROUND OF THE INVENTION

1. Field of the Invention

The present invention relates generally to a method of multi-layer based scalable video coding and decoding and, more particularly, to a method of multi-layer based scalable video encoding and decoding that generates a virtual forward reference frame from a scalable video codec using a multi-layer structure, thus improving forward prediction performance under a low delay condition.

2. Description of the Related Art

As information and communication technology, including the Internet, is developed, communication using images as well as communication using text and voice is increasing. An existing text-based communication method is insufficient to meet customer demands and, therefore, multimedia services that can accommodate various types of information, such as characters, pictures and music, are increasing. The amount of multimedia data is vast and, therefore, it requires large capacity storage media and broad bandwidth for transmission. Accordingly, in order to transmit multimedia data, including text, images and audio data, the use of a compression encoding technique is required.

The fundamental principle of data compression is the removal of redundant data. Data can be compressed by removing spatial redundancy, such as the repetition of the same color or object in an image, by removing temporal redundancy, as in the case where adjacent frames in moving pictures vary little or the case where the same sound is continuously repeated, or by removing psychovisual redundancy which takes into account the fact that human visual and perceptive capabilities are insensitive to high frequencies. In a general video encoding method, temporal redundancy is removed by temporal filtering based on motion compensation, and spatial redundancy is removed by spatial conversion.

In order to transmit multimedia data with the redundancy reduction, transmission media are necessary. The performance of the transmission media differs according to their own characteristics. Currently used transmission media have various transmission speeds ranging from the speed of an ultra high-speed communication network, which can transmit data at a transfer rate of several megabits per second, to the speed of a mobile communication network, which can transmit data at a transfer rate of 384 Kbits per second. In these environments, a scalable video encoding method can support transmission media having a variety of speeds and can transmit multimedia at a transmission speed most suitable for each transmission environment.

Such a scalable video encoding method refers to an encoding method in which encoding is performed in such a manner that, for an already compressed bitstream, part of the bitstream is truncated according to surrounding conditions, such as a transmission bit rate, a transmission error rate and a system source, so that a video resolution, a frame rate, and a Signal-to-Noise Ratio (SNR) can be adjusted. With regard to the scalable video encoding method, standardization has already progressed to Moving Picture Experts Group-21 (MPEG-21) Part 10. In particular, a lot of effort has been made to realize multi-layer based scalability. For example, multiple layers, including a base layer, a first enhancement layer and a second enhancement layer, are provided. In this case, each of the layers can be constructed so as to have a different resolution, that is, a Quarter Common Intermediate Format (QCIF), a Common Intermediate Format (CIF) or a 2CIF, or they can be constructed to have a different frame rate.

FIG. 1 is a diagram showing an example of a conventional scalable video codec using a multi-layer structure. First, a base layer is defined as a layer having a QCIF and a frame rate of 15 Hz, a first enhancement layer is defined as a layer having a CIF and a frame rate of 30 Hz, and a second enhancement layer is defined as a layer having Standard Definition (SD) and a frame rate of 60 Hz. If a CIF 0.5 Mbps stream is required, a bitstream is truncated in order to reach a bit rate of 0.5 Mbps, and is then transmitted under the conditions of CIF_30Hz_0.7 Mbps of the first enhancement layer. In this manner, spatial scalability, temporal scalability and SNR scalability can be realized.

The conventional scalable video codec using a multi-layer structure may be implemented so as to divide each layer into a plurality of temporal levels. FIG. 2 shows the flow of a temporal division process in a Motion Compression Temporal Filtering (MCTF) type scalable video encoding and decoding process.

Of many technologies used for wavelet-based scalable video encoding, the MTCF technology, which was proposed by Ohm and improved by Choi and Wood, is used for removing temporal redundancy and performing temporally flexible and scalable video encoding. In MCTF technology, encoding is performed on a Group Of Pictures (GOP) basis, and a pair of a current frame and a reference frame is temporally filtered in the direction of motion.

As shown in FIG. 2, the encoding is performed in such a way as to convert low temporal level frames into high temporal level low and high frequency frames by temporally filtering the low temporal level frames, and the encoder converts the converted low frequency frames into higher temporal level frames by filtering the converted low frequency frames. An encoder generates a bitstream through wavelet conversion using the highest temporal level low and high frequency frames. In FIG. 2, the dark frames represent frames that are targeted for wavelet conversion. In summary, the encoder performs operation on frames in order from a low level to a high level. A decoder performs operations on the dark-colored frames, which have been acquired by wavelet conversion, in order from a high level to a low level, thereby restoring them to original frames. The MCTF enables the use of a plurality of reference frames and bi-directional prediction, thus enabling more general frame operations. However, in an upper temporal level, some forward prediction paths may not be allowed when a low delay condition is required. In MCTF using bi-directional prediction, a problem occurs in that the encoding efficiency of an input video having slow motion may rapidly decrease when forward prediction is not allowed.

### SUMMARY OF THE INVENTION

Accordingly, the present invention has been made keeping in mind the above problems occurring in the prior art, and an aspect of the present invention is to provide a method of scalable video encoding and decoding, which, when forward prediction cannot be performed under a low delay condition, generates a virtual forward reference frame, thus enabling bi-directional prediction.

Another aspect of the present invention resides in enabling bi-directional prediction using a virtual forward reference frame, thus improving the prediction performance of a scalable video codec.

Aspects of the present invention are not limited to those aspects described above, and other aspects not described above will be clearly understood by those skilled in the art from the following descriptions.

An embodiment of the present invention provides a method of multi-layer based scalable video encoding, including estimating motion between a base layer frame, which is placed at a temporal location closest to a current frame of an enhancement layer, and a frame, which is backwardly adjacent to the base layer frame, to extract a motion vector; generating a residual image by subtracting the backwardly adjacent frame from the base layer frame; generating a virtual forward reference frame using the motion vector, the residual image and the base layer frame; and generating a predicted frame with respect to the current frame using the virtual forward reference frame, and encoding a difference between the current frame and the predicted frame.

In addition, an embodiment of the present invention provides a method of multi-layer based scalable video decoding, comprising extracting a motion vector with respect to a base layer frame, which is placed at a temporal location closest to a current frame of an enhancement layer, and a frame, which is backwardly adjacent to the base layer frame, from a base layer bitstream; restoring a residual image for the base layer and restoring the base layer frame from the residual image; generating a virtual forward reference frame using the motion vector, the restored residual image, and the restored base layer frame; and generating a predicted frame with respect to a current frame using the virtual forward reference frame, and adding a restored difference between the current frame and the predicted frame to the predicted frame.

### BRIEF DESCRIPTION OF THE DRAWINGS

The above and other aspects, features and advantages of the present invention will be more clearly understood from the following detailed description taken in conjunction with the accompanying drawings, in which:

FIG. 1 is a diagram showing an example of a conventional scalable video codec using a multi-layer structure;

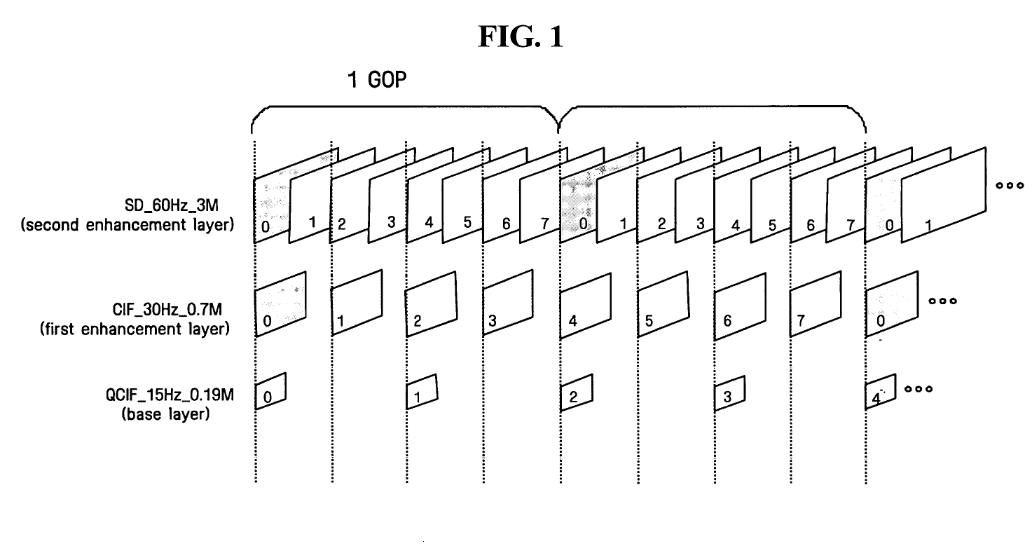

FIG. 2 is a diagram illustrating a flow of a temporal division process in an MCTF type scalable video encoding and decoding process;

FIG. 3 is a diagram illustrating the principle of the generation of a virtual forward reference frame;

FIG. 4 is a diagram illustrating a method of generating a virtual forward reference frame according to an embodiment of the present invention;

FIG. 5 is a diagram illustrating a method of generating a virtual forward reference frame according to another embodiment of the present invention;

FIG. 6 is a block diagram showing the construction of a video encoder according to an embodiment of the present invention;

FIG. 7 is a flowchart illustrating a method of generating a virtual forward reference frame according to the first embodiment of the present invention;

FIG. 8 is a block diagram showing the construction of a video decoder according to an embodiment of the present invention; and

FIG. 9 is a diagram illustrating the performance of scalable video encoding that uses virtual forward reference.

### DESCRIPTION OF EXEMPLARY EMBODIMENTS

Exemplary embodiments of the present invention are described in detail with reference to the accompanying drawings below.

High-energy compression through exact prediction is an essential factor for improving encoding performance in the MCTF process. At the prediction step of an MCTF process, unidirectional prediction, such as backward prediction or forward prediction, can be performed, or bi-directional prediction, which refers to both forward and backward frames, can be performed.

In the present specification, forward prediction refers to temporal prediction that is performed with reference to a frame that is temporally subsequent to a current frame desired to be predicted. In contrast, backward prediction refers to temporal prediction that is performed with reference to a frame that is temporally previous to a current frame that is to be predicted.

When a low delay condition exists, some forward prediction paths of an upper temporal level may not be allowed in the MCTF process. Such a limited condition is not problematic with respect to the encoding efficiency of a video sequence having fast motion, but can result in lowered performance with respect to the encoding efficiency of a video sequence having slow motion.

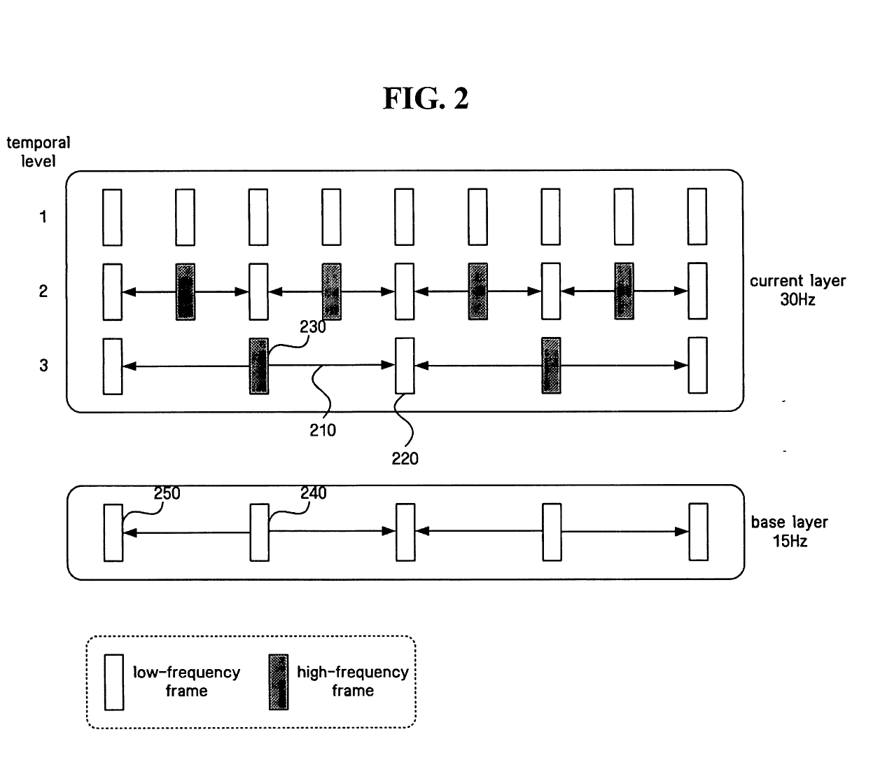

For example, assume that the time corresponding to the frame interval of the temporal level 1 of the current layer of FIG. 2 is 1, and the delay time cannot exceed 1 in a certain video encoding process. In the MCTF process illustrated in FIG. 2, the forward prediction of a temporal level 2 can be performed because the delay time does not exceed 1. In contrast, a delay time of 2 occurs in order to perform the forward prediction 210 of a temporal level 3, so that some forward predicted paths cannot be allowed under the low delay condition where the delay time is less than 1. The video encoding method according to an embodiment of the present invention generates the virtual forward reference frame to replace the forward reference frame 220 missed due to the low delay condition using information about the base layer, and can perform bi-directional prediction using the virtual forward reference frame in the current layer.

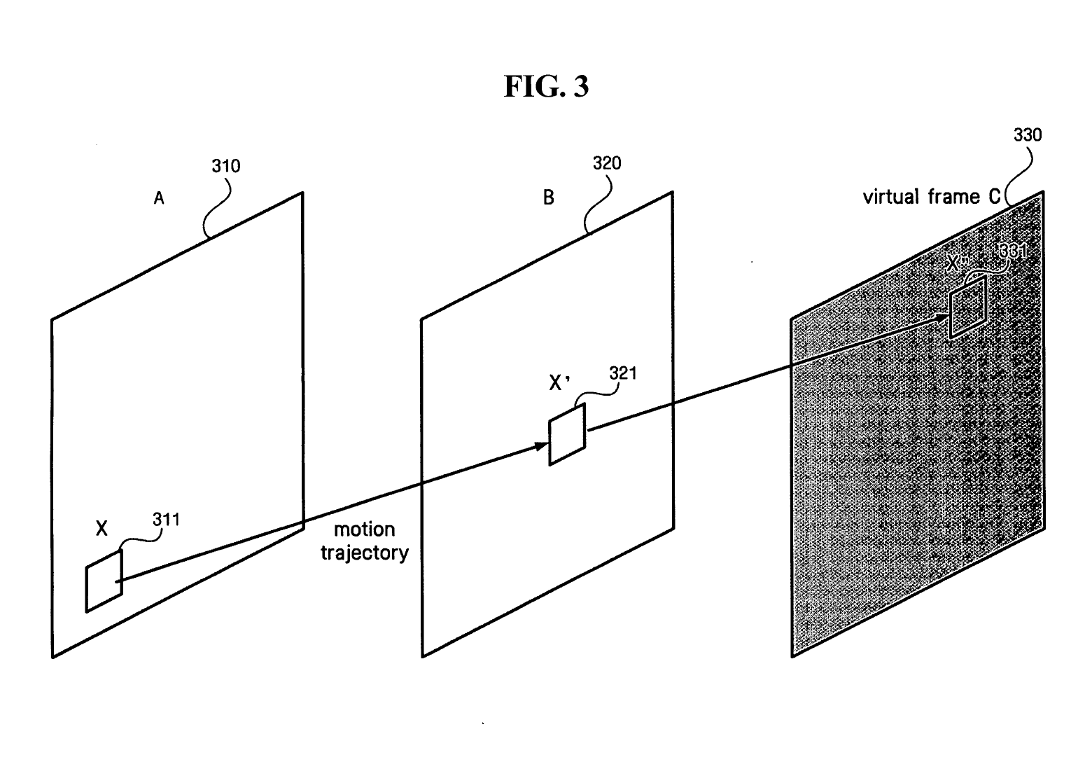

FIG. 3 is a diagram illustrating the principle of generation of a virtual forward reference frame.

The virtual forward reference frame according to the present embodiment can be generated using motion variation and texture variation between the base layer frame (reference numeral 240 in FIG. 2; hereinafter referred to as “frame B”), placed at the temporal location closest to the current frame (reference numeral 230 of FIG. 2), and a frame previous to frame B (reference numeral 250 in FIG. 2; hereinafter referred to as “frame A”). That is, when a specific macroblock X 311 of frame A 310 is matched to a macroblock X′ 321 of frame B 320, it can be estimated that macroblock X′ 321 will be matched to macroblock X″ 331 of the virtual forward reference frame C.

Generally, it may be predicted that the motion from frame B 320 to virtual forward reference frame C 330 will be proportional to time on the extended motion trajectory from frame A 310 and to virtual frame C 330. Accordingly, it can be predicted that the motion vector of virtual forward reference frame C and the motion vector of frame A will be identical in magnitude but opposite to each other in direction. That is, the motion vector of virtual forward reference frame C can be expressed by the multiplication of the motion vector of frame A by −1. Meanwhile, it can be assumed that texture variation between frame B and virtual forward reference frame C will be the same as texture variation between frames A and B. Accordingly, the virtual forward reference frame C, to which texture variation is applied, can be obtained by adding the texture variation between frames A and B to frame B.

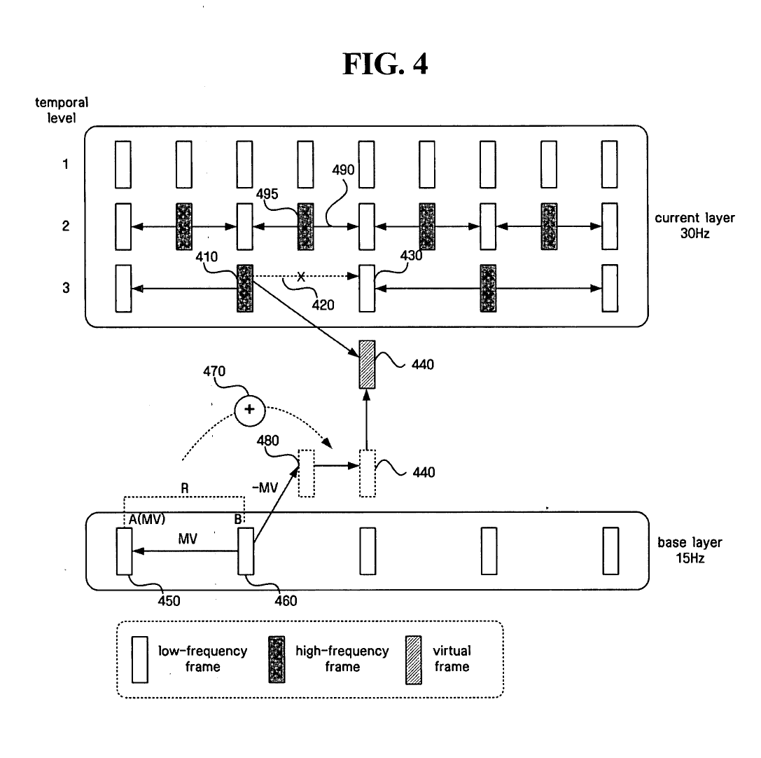

FIG. 4 is a diagram illustrating a method of generating a virtual forward reference frame according to an embodiment of the present invention.

In the temporal level 3, a delay time of 2 occurs to perform forward prediction 420 on a current frame 410. In this case, a forward prediction path cannot be allowed when the low delay condition is required. Accordingly, bi-directional prediction can be performed when a forward reference frame 430, which is missed due to the low delay condition, is replaced with a virtual forward reference frame 440.

The virtual forward reference frame 440 according to an embodiment of the present invention is achieved in such a manner as to obtain a motion vector MV for frame A, which is the backward reference frame of frame B 460, which is a base layer frame having the same temporal location as the current frame 410, and frame A is obtained (MV) 450, which is a motion-compensated backward reference frame based on the motion vector MV. Assuming that reference character R is a residual image that is obtained by subtracting a motion compensation frame A (MV) from frame B, the virtual forward reference frame 440 can be generated by generating a virtual frame 480 obtained by moving restored frame B by a motion vector −MV, adding the restored residual image R to the generated virtual frame 480 in order to apply texture variation and, thus, improve the accuracy of the virtual frame.

Until now, although the case where the delay time is 1 has been described, the same concept can be applied to the case where the delay time is less than 0. For example, assume the forward predicted path 490 of the temporal level 2 is not allowed under a low delay condition. In the case of FIG. 4, the base layer frame does not exist at the temporal location of a frame 495 that is to be currently encoded, so that the virtual forward reference frame 440 can be generated through the process identical to the above-described process using the frame 460 located to the immediate left of the temporal location of the current frame, that is, the frame 460 of backward base layer frames that are closest to the current frame.

In the present embodiment, each macroblock of restored frame B is mapped onto virtual forward reference frame C using a virtually estimated motion vector −MV, so that vacant regions, in which macroblocks mapped onto the virtual forward reference frame do not exist, may be generated. Such vacant regions can be filled using an information filling method, which estimates information from information about a peripheral region, or they can be filled by copying information from an adjacent frame (at the same location) and filling the information into the vacant region.

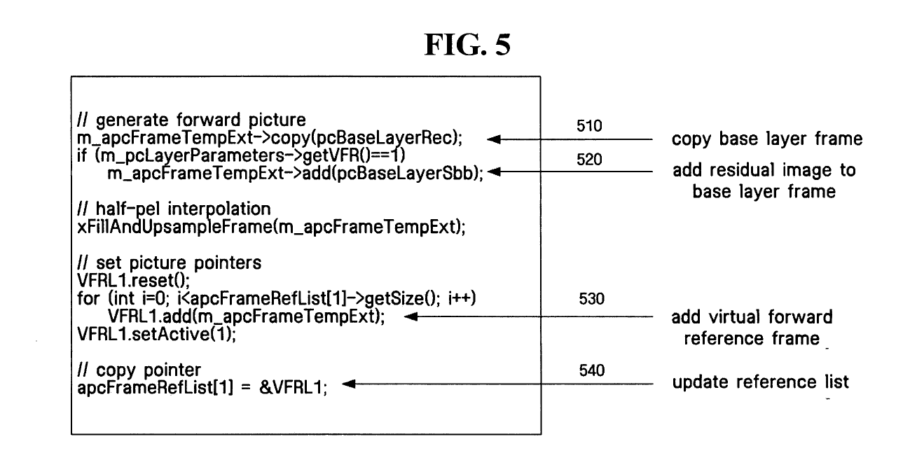

Another embodiment of the present invention may generate the virtual forward reference frame by adding only texture variation to the restored frame B without considering motion movement. FIG. 5 is a diagram illustrating a process of generating the virtual forward reference frame and providing the generated result to the forward reference frame under the condition that only the texture variation is applied thereto using pseudo code.

The embodiment of FIG. 5 generates the virtual forward reference frame by adding residual images corresponding to the texture variation, to frame B under the assumption that the motion movement is ‘0’ in the method of generating a virtual forward reference frame described in FIG. 4. That is, the virtual forward reference frame is generated in such a way as to copy the base layer frame B (510) and add the residual image of frame B and frame A, which is the backward reference frame of frame B, to frame B (520). The generated virtual forward reference frame is added to a reference list as a new reference frame (530 and 540). The present embodiment can be applied to the case where almost no motion variation exists or the speed of motion is very slow and video-encoding efficiency can be improved with only a simple implementation.

A further embodiment of the present invention may generate the virtual forward reference frame only by moving restored frame B according to the motion vector −MV, without considering texture variation.

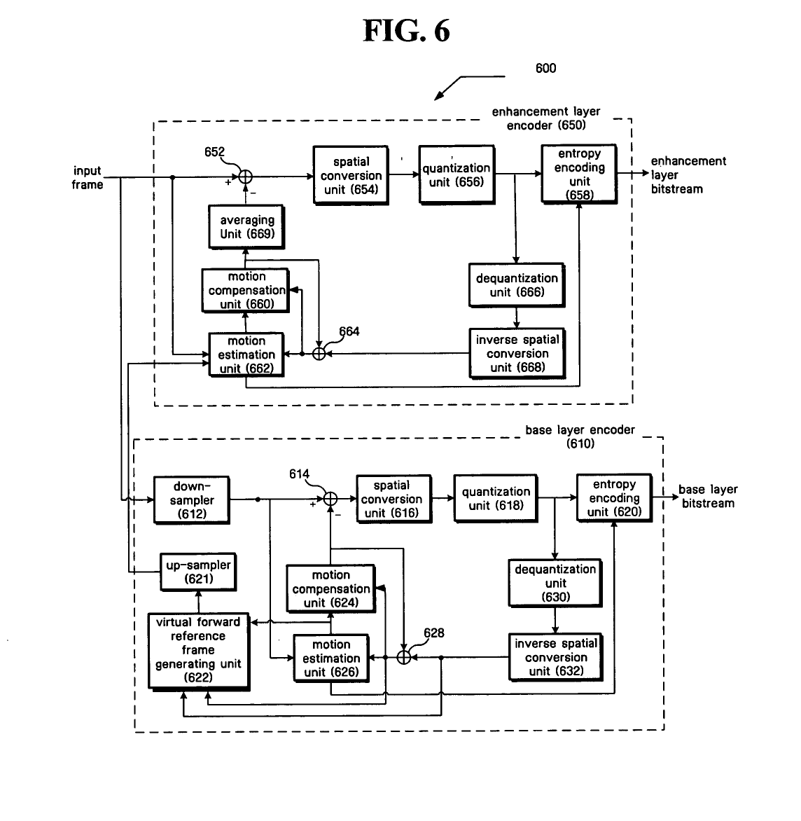

FIG. 6 is a block diagram showing the construction of a video encoder 600 according to an embodiment of the present invention. The video encoder 600 may include a base layer encoder 610 and an enhancement layer encoder 650.

The enhancement layer encoder 650 may include a spatial conversion unit 654, a quantization unit 656, an entropy encoding unit 658, a motion estimation unit 662, a motion compensation unit 660, a dequantization unit 666, an inverse spatial conversion unit 668, and an averaging unit 669.

The motion estimation unit 662 performs motion estimation on a current frame based on the reference frame of input video frames and obtains a motion vector. Under a low delay condition, the motion estimation unit 662 of the present embodiment receives an up-sampled virtual forward reference frame as a forward reference frame from the up-sampler 621 of the base layer as needed, and obtains a motion vector for forward prediction or bi-directional prediction. An algorithm widely used for motion estimation is the block matching algorithm. The block matching algorithm block estimates the displacement of a given motion block (while minimizing error) to be a motion vector while moving the motion block within a specific search region of the reference frame on a pixel basis. Motion blocks having fixed sizes may be used to perform motion estimation. Furthermore, motion estimation may be performed using motion blocks having variable sizes based on Hierarchical Variable Size Block Matching (HVSBM). The motion estimation unit 662 provides motion data, which is obtained as the result of the motion estimation, to the entropy encoding unit 658. The motion data includes one or more motion vectors, and may further include information about motion block sizes and reference frame numbers.

The motion compensation unit 660 performs motion compensation on a forward reference frame or a backward reference frame using the motion vector calculated by the motion estimation unit 662, thus generating a temporal prediction frame with respect to the current frame.

The averaging unit 669 receives the motion-compensated virtual forward reference frames as the motion-compensated backward and forward reference frames with respect to the current frame from the motion compensation unit 660, calculates the average value of both of the images, and generates a bi-directional prediction frame with respect to the current frame.

The subtractor 652 subtracts the current frame and the bi-directional and temporal prediction frame generated by the averaging unit 669, thus removing temporal redundancy from a video.

The spatial conversion unit 654 removes spatial redundancy that supports spatial scalability, from the frame from which temporal redundancy has been removed by the subtractor 652, using a spatial conversion method. The Discrete Cosine Transform (DCT) method or a wavelet transform method is chiefly used as the spatial conversion method. A coefficient obtained by the result of spatial conversion is called a conversion coefficient. In particular, the coefficient is called a DCT coefficient when DCT is used for spatial conversion and a wavelet coefficient when wavelet transform is used for spatial conversion.

The quantization unit 656 quantizes the conversion coefficient obtained by the spatial conversion unit 654. Quantization refers to a process of representing the conversion coefficient with discrete values by dividing the conversion coefficient at predetermined intervals, and matching the discrete value to a predetermined index. Particularly, in the case of using the wavelet transform method as a spatial conversion method, an embedded quantization method is chiefly used as the quantization method.

The entropy encoding unit 658 encodes the quantized conversion coefficients acquired by the quantization unit 656, and motion data is provided by the motion estimation unit 662, without loss, thus generating an output bitstream. An arithmetic encoding method or a variable length encoding method may be used as the lossless encoding method.

The video encoder 600 may further include a dequantization unit 666 and an inverse spatial conversion unit 668, in the case where closed loop video encoding is supported to reduce a drifting error between an encoder and a decoder.

The dequantization unit 666 dequantizes the quantized coefficients acquired by the quantization unit 656. Dequantization is the inverse of the quantization process.

The inverse spatial conversion unit 668 performs inverse spatial conversion on dequantization results, and provides the conversion results to an adder 664.

The adder 664 adds a predicted frame, which is provided by the motion compensation unit 660, and is stored in a frame buffer (not shown), and a restored residual frame, which is provided by the inverse spatial conversion unit 668, thus restoring a video frame, and provides the restored video frame to the motion estimation unit 662 as a reference frame.

The base layer encoder 610 may include a spatial conversion unit 616, a quantization unit 618, an entropy encoding unit 620, a motion estimation unit 626, a motion compensation unit 624, a dequantization unit 630, an inverse spatial conversion unit 632, a virtual forward reference frame generating unit 622, a down-sampler 612, and an up-sampler 621. For ease of description, the up-sampler 621 is included in the base layer encoder 610, but it may be located in the video encoder 600.

The virtual forward reference frame generating unit 622 receives the motion vector of a backward reference frame from the motion estimation unit 626, a restored video frame from an adder 628, and restored residual images, that is, results acquired by restoring the difference of a current frame and a temporal prediction frame, from the inverse spatial conversion unit 632, and generates a virtual forward reference frame. The virtual forward reference frame may be generated using the method described above with reference to FIG. 4 or 5.

The down-sampler 612 performs down-sampling on an original input frame based on the resolution of the base layer. This assumes that the resolution of the enhancement layer and the resolution of the base layer are different, so that the down-sampling process may be omitted when the resolutions of both of the layers are the same.

The up-sampler 621 performs up-sampling on the virtual forward reference frame output from the virtual forward reference frame generating unit 622 as needed, and provides up-sampled results to the motion estimation unit 662 of the enhancement layer encoder 650. When the resolution of the enhancement layer and the resolution of the base layer are the same, the up-sampler 621 need not be used.

Since the operations of the spatial conversion unit 616, the quantization unit 618, the entropy encoding unit 620, the motion estimation unit 626, the motion compensation unit 624, the dequantization unit 630, and the inverse spatial conversion unit 632 are the same as those of the components of the enhancement layer, the descriptions of the components having names identical to those of the basic layer have been omitted.

Until now, a plurality of components, the reference numerals of which are different but the terms of which are identical, have been described as existing in the system depicted in FIG. 6. However, it should be apparent to those skilled in the art that a single component having a specific name can perform related operations on the base layer and the enhancement layer.

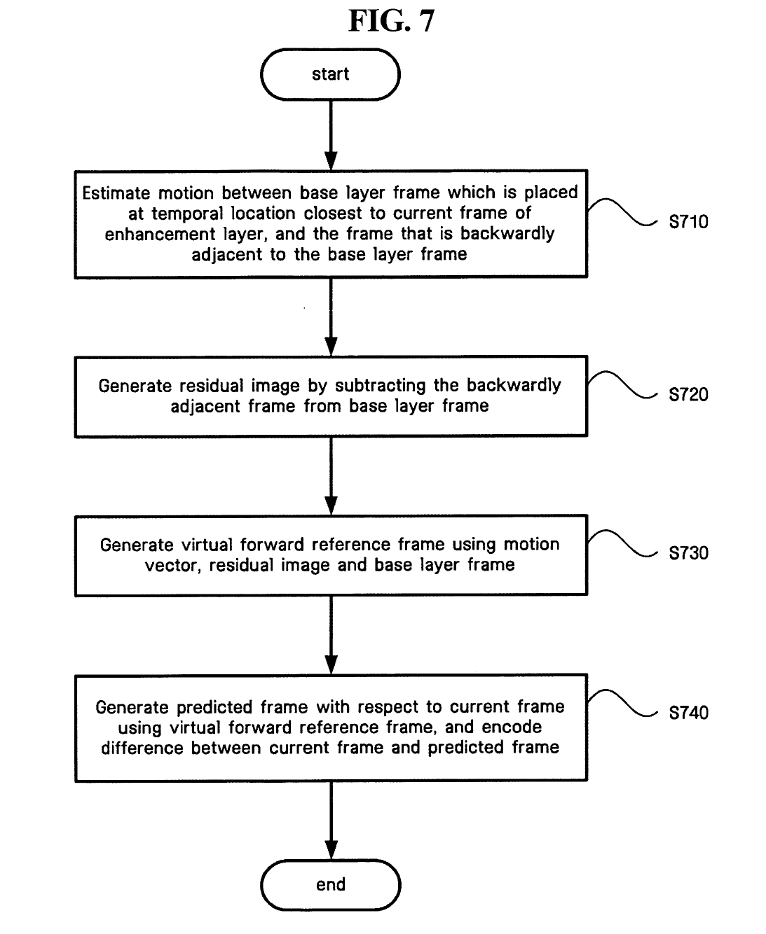

FIG. 7 is a flowchart illustrating a method of generating a virtual forward reference frame according to the first embodiment of the present invention.

When a forward reference path is not allowed due to a low delay condition, motion between a base layer frame, which is placed at the temporal location closest to the current frame of an enhancement layer, and a frame, which is backwardly adjacent to the base layer frame, is estimated to extract a motion vector in step S710. In this case, the closest temporal location, as described above, refers to a location identical to a temporal location of the current frame or the backward location closest to the identical temporal location when no base layer frame exists at the identical temporal location.

In step S720, a residual image is acquired by subtracting a backwardly adjacent frame, which is compensated by the motion vector, from the base layer frame. The residual image includes information about the texture variation between the base layer frame and the backwardly adjacent frame. The information may include information about the variation in brightness and chrominance.

In step 730, a virtual forward reference frame is generated using the motion vector, the residual image and the base layer frame. As illustrated in FIGS. 4 and 5, a vector, the magnitude of which is the same as that of the motion vector extracted in step S710, and the direction of which is opposite to that of the motion vector, is estimated as the motion vector of the virtual forward reference frame, and a virtual frame is generated by performing motion compensation on the base layer frame using the estimated motion vector. In order to increase the accuracy of the virtual forward reference frame, the residual image generated in step S720 is added to the virtual frame.

Thereafter, in step S740, a predicted frame with respect to the current frame is generated using the virtual forward reference frame, and the difference between the current frame and the predicted frame is encoded. The predicted frame, which is a bi-directional prediction frame, may be generated from the arithmetic average of the backward reference frame and the virtual forward reference frame in the enhancement layer of the current frame. The difference between the current frame and the predicted frame is encoded through spatial variation, quantization and entropy encoding steps.

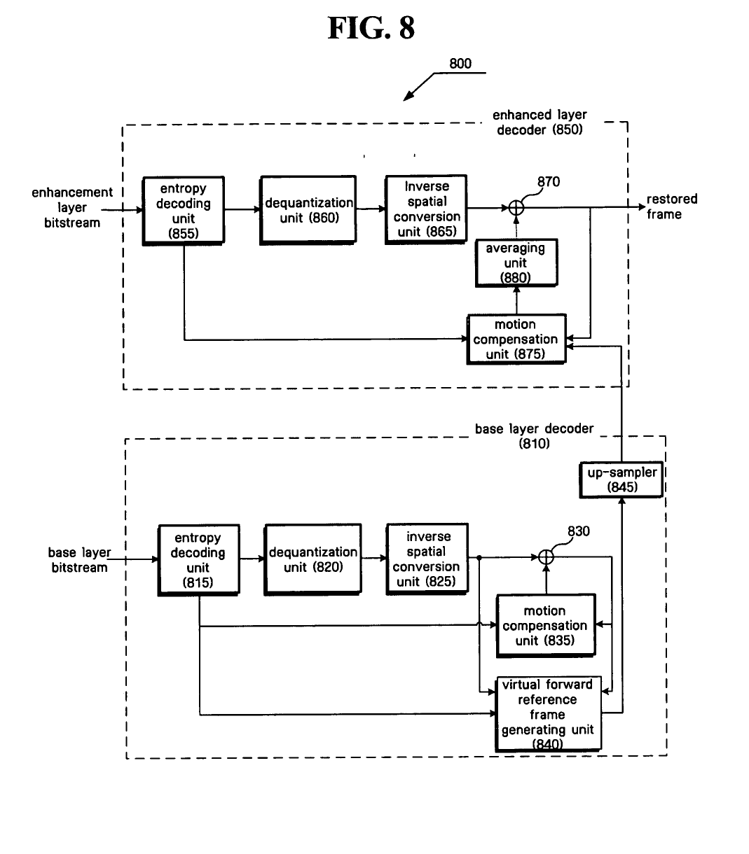

FIG. 8 is a block diagram showing the construction of a video decoder 800 according to an embodiment of the present invention. The video decoder 800 may include a base layer decoder 810 and an enhancement layer decoder 850.

The enhancement layer decoder 850 may include an entropy decoding unit 855, a dequantization unit 860, an inverse spatial conversion unit 865, a motion compensation unit 875, and an averaging unit 880.

The entropy decoding unit 855 performs lossless decoding in an inverse manner relative to the encoding of the entropy encoding method, thus extracting motion data and texture data. The texture data is provided to the dequantization unit 860, and the motion data is provided to the motion compensation unit 875.

The dequantization unit 860 dequantizes the texture data transferred from the entropy decoding unit 855. Such a dequantization process is a process of finding quantization coefficients matched to values that the encoder 600 provides in a predetermined index form.

The inverse spatial conversion unit 865 inversely performs spatial conversion, and restores coefficients, which are generated as a result of the dequantization, to the residual image in a spatial domain. For example, the inverse spatial conversion unit 865 performs inverse wavelet conversion when the spatial conversion has been performed in the video encoder according to the wavelet method, and performs IDCT when the spatial conversion is performed in the video encoder based on the DCT method.

The motion compensation unit 875 performs motion compensation on the restored video frame and generates a motion-compensated frame, using the motion data provided by the entropy decoding unit 855. In this case, the base layer decoder 810 receives the virtual forward reference frame sampled up by the up-sampler 845 and performs motion compensation on the received virtual forward reference frame when bi-directional prediction is conducted under a low delay condition. The motion compensation process is limitedly applied only in the case where the current frame is encoded in the encoder through a temporally predicted process.

The averaging unit 880 receives a motion-compensated backward reference frame and a motion compensated virtual forward reference frame from the motion compensation unit 875 and calculates the average of the motion-compensated backward reference frame and the motion compensated virtual forward reference frame, in order to restore the bi-directional prediction frame and provide the restored frame to the adder 870.

The adder 870 adds the residual image, which is restored by the inverse spatial conversion unit 865, and the bi-directional prediction frame, which is received from the averaging unit 880, thus restoring the original video frame.

The base layer decoder 810 may include an entropy decoding unit 815, a dequantization unit 820, an inverse spatial conversion unit 825, a motion compensation unit 835, a virtual forward reference frame generating unit 840, and an up-sampler 845.

The entropy decoding unit 815 performs lossless decoding in an order inverse to the entropy encoding method, thus extracting motion data and texture data. The texture data is provided to the dequantization unit 820, and the motion data is provided to the motion compensation unit 835 and the virtual forward reference frame generating unit 840.

The virtual forward reference frame generating unit 840 receives a motion vector from the entropy decoding unit 815, receives residual image values from the inverse spatial conversion unit 825, and receives the restored image from the adder 830. Thereafter, the virtual forward reference frame generating unit 840 generates a virtual forward reference frame based on the methods illustrated in FIGS. 4 and 5 and provides the generated virtual forward reference frame to the up-sampler 845. When the resolution of the base layer and enhancement layer are the same, the virtual forward reference frame is provided to the motion compensation unit 875 of the enhancement layer decoder without passing through the up-sampler 845.

The up-sampler 845 performs up-sampling on a base layer image, which has been restored by the base layer decoder 810, to bring it to the resolution of the enhancement layer and provides the up-sampled image to the motion compensation unit 875. Such an up-sampling process may be omitted when the resolution of the base layer and the enhancement layer are the same.

Since the operations of the dequantization unit 820, the inverse spatial conversion unit 825 and the motion compensation unit 835 are the same as those of the components of the enhancement layer, the descriptions of the components having names identical to those of the basic layer have been omitted.

In the previous description, a plurality of components, the reference numerals of which are different but the terms of which are identical, have been described as existing in the system depicted in FIG. 8. However, it should be apparent to those skilled in the art that a single component having a specific name can perform related operations on the base layer and the enhancement layer.

The respective components of FIGS. 6 and 8 may refer to software and hardware, such as a Field-Programmable Gate Array (FPGA) and an Application-Specific Integrated Circuit (ASIC). However, the components are not limited to software or hardware, and may be constructed to reside in an addressable storage medium, or they may be constructed so as to reproduce one or more processes. The functions provided within the components may be realized by subdivided components, or the aggregation of the components may be realized as a single component that performs a specific function.

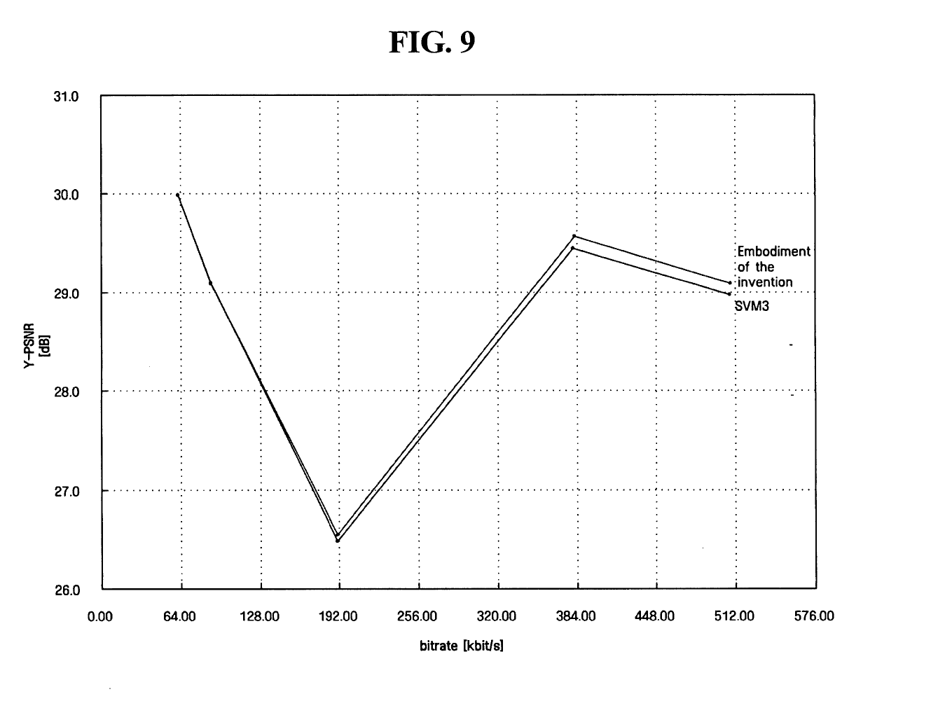

FIG. 9 is a diagram illustrating scalable video encoding performance using virtual forward reference.

With reference to FIG. 9, it can be seen that the present invention can achieve a Peak Signal to Noise Ratio (PSNR) higher than that of the conventional method to which general Support Vector Machine (SVM) 3 is applied when encoding is performed using the virtual forward reference frame.

As described above, the method of the scalable video encoding and decoding according to the present invention provides one or more following effects.

First, the present invention is advantageous in that, even when forward prediction cannot be performed under a low delay condition, it generates a virtual forward reference frame using information about the enhancement layer, thus enabling forward prediction or bi-directional prediction.

Second, the present invention is advantageous in that it enables bi-directional prediction using the virtual forward reference frame under a low delay condition, so that the prediction performance of a scalable video codec can be improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of multi-layer based scalable video encoding comprising:
(a) estimating motion between a base layer frame, which is placed at a temporal location closest to a current frame of an enhancement layer, and a frame, which is backwardly adjacent to the base layer frame, to extract a motion vector;
(b) generating a residual image by subtracting the backwardly adjacent frame from the base layer frame;
(C) generating a virtual forward reference frame using the motion vector, the residual image and the base layer frame; and
(d) generating a predicted frame with respect to the current frame using the virtual forward reference frame, and encoding a difference between the current frame and the predicted frame.

2. The method of claim 1, wherein the closet temporal location is identical to a temporal location of the current frame of the enhancement layer.

3. The method of claim 1, wherein the closest temporal location is a location backwardly closest to the current frame of the enhancement layer.

4. The method of claim 1, wherein (c) comprises:
(c1) generating a virtual frame by performing motion compensation on the base layer frame using a vector, the magnitude of which is identical to that of the motion vector and the direction of which is opposite to that of the motion vector; and
(c2) adding the residual image to the virtual frame.

5. A method of multi-layer based scalable video encoding comprising:
(a) estimating motion between a base layer frame, which is placed at a temporal location closest to a current frame of an enhancement layer, and a frame, which is backwardly adjacent to the base layer frame, to extract a motion vector;
(b) generating a virtual forward reference frame using the motion vector; and
(c) generating a predicted frame with respect to the current frame using the virtual forward reference frame, and encoding the difference between the current frame and the predicted frame.

6. The method of claim 5, wherein (b) generates the virtual forward reference frame by performing motion compensation on the base layer frame using a vector, the magnitude of which is identical to that of the motion vector and the direction of which is opposite to that of the motion vector.

7. A method of multi-layer based scalable video encoding comprising:
(a) acquiring a residual image between a base layer frame, which is placed at a temporal location closest to a current frame of an enhancement layer, and a frame, which is backwardly adjacent to the base layer frame;
(b) generating a virtual forward reference frame using the residual image; and
(c) generating a predicted frame with respect to the current frame using the virtual forward reference frame, and encoding the difference between the current frame and the predicted frame.

8. The method of claim 7, wherein (b) adds the residual image to the base layer frame.

9. A method of multi-layer based scalable video decoding comprising:
(a) extracting a motion vector with respect to a base layer frame that is placed at a temporal location closest to a current frame of an enhancement layer, and a frame that is backwardly adjacent to the base layer frame, from a base layer bitstream;
(b) restoring a residual image for the base layer and restoring the base layer frame from the residual image;
(c) generating a virtual forward reference frame using the motion vector, the restored residual image, and the restored base layer frame; and
(d) generating a predicted frame with respect to a current frame using the virtual forward reference frame, and adding a restored difference between the current frame and the predicted frame to the predicted frame.

10. The method of claim 9, wherein the closest temporal location is identical to the temporal location of the current frame of the enhancement layer.

11. The method of claim 9, wherein the closest temporal location is the location backwardly closest to the current frame of the enhancement layer.

12. The method of claim 9, wherein (c) comprises:
(c1) generating a virtual frame by performing motion compensation on the restored base layer frame using a vector, the magnitude of which is identical to that of the motion vector and the direction of which is opposite to that of the motion vector; and
(c2) adding the restored residual image to the virtual frame.

13. A method of multi-layer based scalable video decoding comprising:
(a) extracting a motion vector with respect to a base layer frame that is placed at a temporal location closest to a current frame of an enhancement layer, and a frame that is backwardly adjacent to the base layer frame, from a base layer bitstream;
(b) generating a virtual forward reference frame using the motion vector; and
(c) generating a predicted frame with respect to the current frame using the virtual forward reference frame, and adding the restored difference between the current frame and the predicted frame to the predicted frame.

14. The method of claim 13, wherein (b) generates the virtual forward reference frame by performing motion compensation on the base layer frame using a vector, the magnitude of which is identical to that of the motion vector and the direction of which is opposite to that of the motion vector.

15. A method of multi-layer based scalable video decoding comprising:
(a) restoring a residual image between a base layer frame that is placed at a temporal location closest to a current frame of an enhancement layer, and a frame that is backwardly adjacent to the base layer frame;
(b) restoring the base layer frame;
(c) generating a virtual forward reference frame using the restored residual image and the restored base layer frame; and
(d) generating a predicted frame with respect to the current frame using the virtual forward reference frame, and adding the restored difference between the current frame and the predicted frame to the predicted frame.

16. The method of claim 15, wherein (b) adds the restored residual image to the restored base layer frame.

17. A multi-layer based scalable video encoder comprising:
a temporal conversion unit configured to estimate motion between a base layer frame, which is placed at a temporal location closest to a current frame of an enhancement layer, and a frame that is backwardly adjacent to the base layer frame, to extract a motion vector, and to acquire a residual image between a base layer frame and the frame that is backwardly adjacent to the base layer frame using the motion vector;
a spatial conversion unit configured to remove spatial redundancy of input video frames;
a quantization unit configured to quantize conversion coefficients acquired by the temporal conversion unit and the spatial conversion unit;
an entropy encoding unit configured to encode without loss the conversion coefficients, which are quantized by the quantization unit, and motion data, which is provided by the temporal conversion unit, and to output a bitstream; and
a virtual forward predicted frame generating unit configured to generate a virtual forward reference frame using the motion vector, the residual image, and the base layer frame;
wherein the temporal conversion unit generates a predicted frame with respect to the current frame using the virtual forward reference frame, and obtains a difference between the current frame and the predicted frame.

18. A multi-layer based scalable video decoder comprising:
an entropy decoding unit configured to extract a motion vector between a base layer frame, which is placed at a temporal location closest to a current frame of an enhancement layer, and frames, which are backwardly adjacent to the base layer frame, from a base layer bitstream;
a dequantization unit configured to dequantize information about encoded frames output by the entropy decoding unit, and to acquire conversion coefficients;
an inverse temporal conversion unit configured to restore a residual image between the base layer frame and the frame that is backwardly adjacent to the base layer frame through inverse temporal conversion;
an inverse spatial conversion unit configured to restore a residual image between the base layer frame and the frame that is backwardly adjacent to the base layer frame through inverse spatial conversion; and
a virtual forward reference frame generating unit configured to generate a virtual forward reference frame using the motion vector, the restored residual image, and the restored base layer frame;
wherein the inverse temporal conversion unit generates a predicted frame with respect to the current frame using the virtual forward reference frame, and obtains a restored difference between the current frame and the predicted frame.

19. A computer-recordable storage medium storing a program for executing the method of claim 1.

20. A computer-recordable storage medium storing a program for executing the method of claim 5.

21. A computer-recordable storage medium storing a program for executing the method of claim 7.

22. A computer-recordable storage medium storing a program for executing the method of claim 9

23. A computer-recordable storage medium storing a program for executing the method of claim 13.

24. A computer-recordable storage medium storing a program for executing the method of claim 15.
